(19) United States
(12) Patent Application Publication
(10) Pub. No.: US 2022/0075339 A1
(43) Pub. Date: Mar. 10, 2022

(54) Process Monitoring System and Method for Operating the Process Monitoring System

(71) Applicant: Siemens Aktiengensellschaft, Muenchen (DE)

(72) Inventor: Benjamin LUTZ, Pfinztal (DE)

(21) Appl. No.: 17/469,231

(22) Filed: Sep. 8, 2021

(30) Foreign Application Priority Data
Sep. 9, 2020 (EP) 20195292

(51) Int. Cl. G05B 19/05; G05B 19/04

(52) U.S. Cl. CPC G05B 19/054; G05B 19/058; G05B 19/041; G05B 2219/163; G05B 2219/14005; G05B 2219/15009; G05B 2219/14097

(57) ABSTRACT

A process monitoring system includes a control unit connected to a server that includes an alarm household, an alarm list that includes alarm messages and a visualization service that includes a variable household, wherein the visualization service is configured to supply the control unit with process values and alarm messages, the first control unit is configured to indicate a process object with its process values in an input/output window and indicate a message sequence display with alarm messages, the input/output window includes an input field and activation area, a manager creates an alarm instance for a process object assigned to the input field when a short message is input and an activation area is activated, and the first control unit stores the assigned short message as a further alarm message in the alarm list, where the message sequence display is extended to indicate the further alarm messages as short messages.

### BACKGROUND OF THE INVENTION

### 1. Field of the Invention

The invention relates to industrial automation systems and, more particularly, to a process monitoring system and method for operating the process monitoring system.

### 2. Description of the Related Art

Immersive technologies, such as Virtual (VR) and Augmented Reality (AR), or virtual environments, such as Cave Automatic Virtual Environment (CAVE), are also becoming increasingly important in the industrial sector. Immersive means that the virtual reality is largely perceived as real. In particular, the interactive visualization of machines in a virtual reality, in particular the user interface and the operator of the machines and the machine controls or the operating and monitoring devices used therein enable highly promising applications.

According to the prior art, what are known as Supervisory Control and Data Acquisition (SCADA) systems are used for the automated control and monitoring of processes and installations. These are understood to be monitoring and control systems that enable the monitoring, control and visualization of industrial processes. Component parts of these control systems are inter alia hardware components, such as sensors, PLCs or technology modules for measuring and transmitting process values and on the other hand software components, such as a Simatic WinCC manufactured by the company Siemens AG. A system of this type has a number of user interfaces, alarm management, data archiving and process visualization.

WO 2017/215885 A1 discloses a system of this type and a method of operation.

One of the key requirements for the successful implementation of future digitization projects consists in the increased replacement of currently established manual actions, which are performed by people in most cases intuitively, based on empirical values, via automated and digitized sequences. Workflows of this type are deterministic, designed to be reproducible as efficiently as possible and furthermore enable a traceability. Within the meaning of the invention, a manual action is for instance when an operator leaves an adhesive label (post-it) with notes for the subsequent shift, such as an overview of the actions or causes of specific malfunctions/anomalies determined or brought about by the operator or outstanding operations still to be performed and thus contains the instructions to be observed by the replacement shift.

One partly digitized analogum relating to the notes is represented by the memo function integrated into process control systems, such as WinCC or PC7 manufactured by the company Siemens. With the aid of this function, similarly to the use of post-its, the operators can leave behind notes, information or short messages that are important to each other.

The disadvantage with known memos that are generally linked to process objects is that they can currently only be created in one view (face plates), where the view in turn contains a memo view, and can also be read again. What is known as an “active memo” option makes it possible to determine whether the memo can still be taken into account or completed or is already completed. Actions that are essentially important to the operation of the installation are often stored in memos, such as a valve has to be closed again at a specific time. Consequently, on no account are these allowed to be overlooked or considered behind schedule. If, within the scope of his routine work, an operator is not continuously informed about instructions that are pending, are to be processed and are to be considered, this may have fatal consequences because, e.g., a valve was not closed at a specific time.

### SUMMARY OF THE INVENTION

In view of the foregoing, its therefore an object of the invention to provide a method and a system that improves the safety of a process monitoring system, in particular for workflows that an operator performs based on manual actions.

This and other objects and advantages are achieved in accordance with the invention by a processing monitoring system including at least one first control unit, which is connected to a server, where the server has a visualization service for monitoring an automation installation, which is configured with a tag management for process values from a process image, and which is furthermore configured with an alarm management and an alarm list with alarm messages and the visualization service is configured to supply the at least first control unit with process values and alarm messages, where the first control unit is configured to indicate a process object with its process values in an input/output field.

The first control unit is furthermore configured to indicate a message sequence display with alarm messages from the alarm list, where the input/output window is configured with an input field for short messages and furthermore has an activation means, where a management component for managing the process objects is present, and this is configured to create an alarm instance for the process object assigned to the input field when a short message is input and an activation means is activated, and to store the assigned short message as a further alarm message in the alarm list, where the message sequence display is extended to indicate the further alarm messages from the alarm list as short messages.

An essential advantage of the invention is considered to be that an operator can now also identify on another control unit via the already available message sequence system whether there are urgent short messages for him or whether instructions are to be taken into account for the process object to be operated. Evaluation of an alarm history can likewise determine which urgent memos or short messages have been processed and concluded in the past by which operator and in which period of time.

A thus realized interaction of memos in an existing alarm management allows a short message to be embedded into an existing alarm management and provides for improved operation and observation of the process or the process objects.

For instance, an input field is extended by the option “trigger alarm”. If an operator also sets this trigger with the creation of the short message, then a corresponding reminder alarm is triggered.

In a further embodiment of the system, the further alarm messages with the assigned short messages have a reference to the alarm instances.

The alarm instance is assigned to the process objects. As a result, it is now advantageously possible to switch from the message sequence display with the aid of the reference into a detailed view relating to the process objects, such that a loop-in is in effect realized in relation to the process object.

Furthermore, provision is advantageously made for a message list to be available as an archive for the assigned short messages. It is accordingly possible to trace when an operator control action was completed and by whom, based on a short message, and the thus associated reminder alarm is completed. The advantages are realized here in particular for an audit trail of an installation operation. A traceability for small, short messages and operator control actions has in effect been created.

The process objects advantageously have a data network and the data network has, aside from other data types, the reference as a data element in its structure. Within the meaning of the invention, a structure of data can be considered to be a data network, such as a motor structure with the data types of temperature, speed, brake effect, power and additionally now according to the data type memo for a short message.

The message sequence display is furthermore advantageously configured with a means of showing the detail of the process object assigned to the short message using the reference. By actuating the detailed display, it is possible to switch to the loop-in function, for instance.

Furthermore, the message sequence display is configured to represent the short message as an acknowledgment-requiring alarm message and accordingly an acknowledgment mechanism is available.

Thus, with the disclosed embodiments of the invention a process monitoring system and a method or an implementation is presented, on the basis of which short messages from process objects can interact with an existing alarm management and an improved operation and observation is now possible, because particularly important short messages can occur omni-presently, if necessary.

Similarly, it is also an object of the invention to provide a method for operating a process monitoring system, in which at least one first control unit exchanges data with a server, where the server is operated with a visualization service to monitor an automation installation, where the visualization service updates the process values to a process image with a variable household for process values. Furthermore, process values and alarm messages are provided with an alarm household and an alarm list with alarm messages via the visualization service of the at least first control unit, where the first control unit indicates a process object with its process values when called up by a user in an input/output window, and within the first control unit a message sequence display is indicated with alarm messages from the alarm list.

With the disclosed method, the object cited in the introduction is achieved in that the input/output window provides an input field for short messages and the short messages are activated via an activation means, where a management component is operated to manage the process objects such that, when a short message is entered and an activation means is activated for the process object assigned to the input field, an alarm instance is created and the assigned short message is stored as a further alarm message in the alarm list, where the further alarm messages from the alarm list are indicated as short messages in the message sequence display.

Memos or notices cannot now be overlooked on the basis of the short message entered in the alarm system, because an alarm triggered by this invention from a short message is also made visible in the message sequence display. If an operator, as described, produces a short message via the input window (face plate) of a process object, an alarm created for this purpose in the process image of the server is triggered via a software component responsible therefor, for instance the CSDL, it applies in particular for each short message that a separate active instance of the alarm is created. Advantageously, the alarm itself also contains a reference to the relevant short message, such that a loop-in relating to the short message view of the relevant process object can also be performed from a message sequence display. An operator of another operator station can now identify via the conventional message sequence display whether there are urgent short messages for him that are still to be processed.

Accordingly, with the disclosed method a reference to the alarm instances is advantageously assigned to the further alarm messages with the assigned short messages.

For better traceability, in particular for an audit trail, in the method a message list, as an archive, is filled and continuously stored with the assigned short messages.

In accordance with the method, it is advantageous for the process objects to be produced with a data network and for the data network, in addition to other data types, to be assigned the reference.

For improved operability and a subsequent detailed view, the message sequence display is operated with a means for the detailed display of the process object assigned to the short message and to this end the reference is used for calling up the details.

It is considered to be particularly advantageous if the message sequence display represents the short message as an acknowledgement-requiring alarm message and accordingly an acknowledgement mechanism is provided for a user.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail on the basis of the drawings, in which:

FIG. 1 is an exemplary embodiment of the arrangement in accordance with the invention; and

FIG. 2 is a flowchart of the method in accordance with the invention.

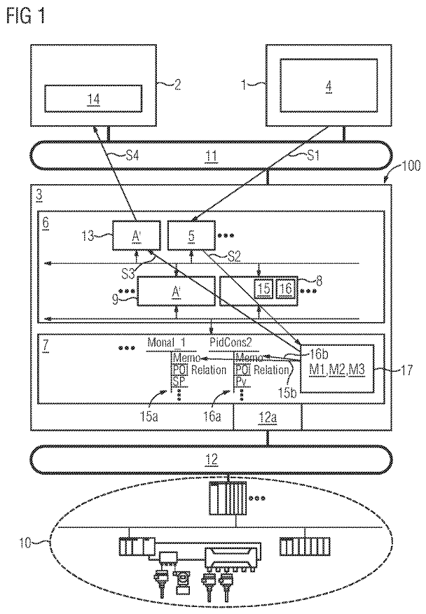

FIG. 1 shows a process monitoring system with a connected automation installation in accordance with the invention;

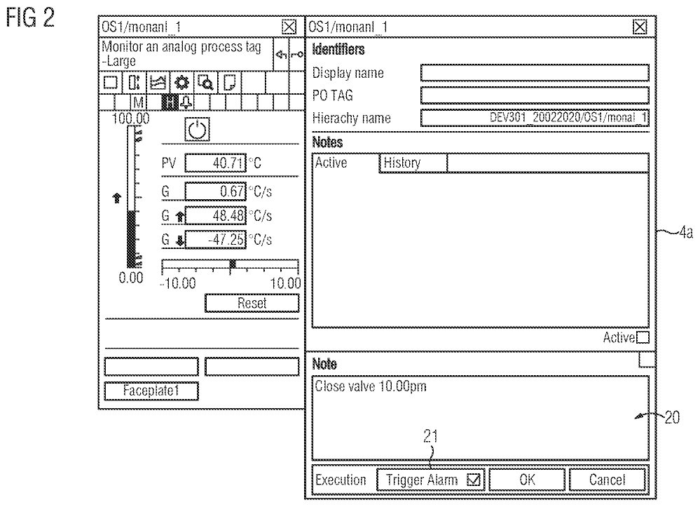

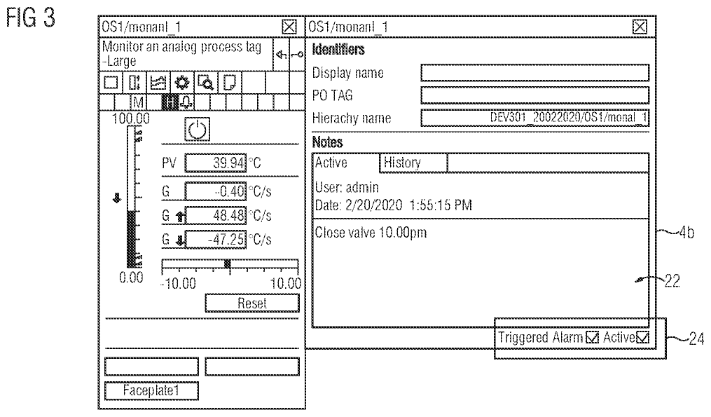

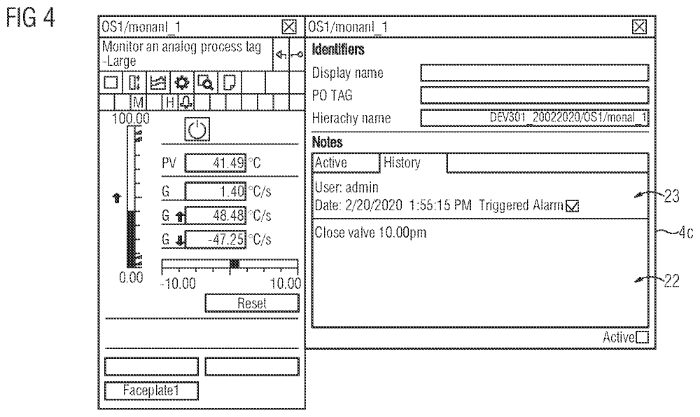

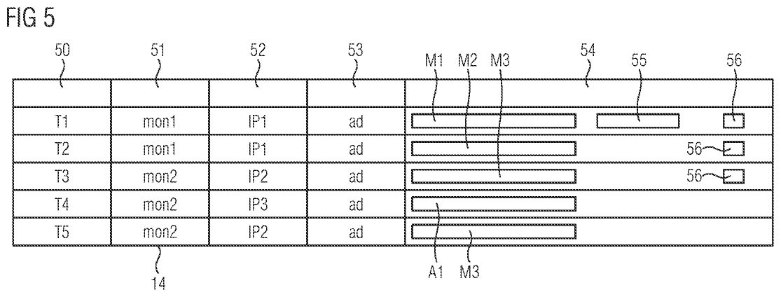

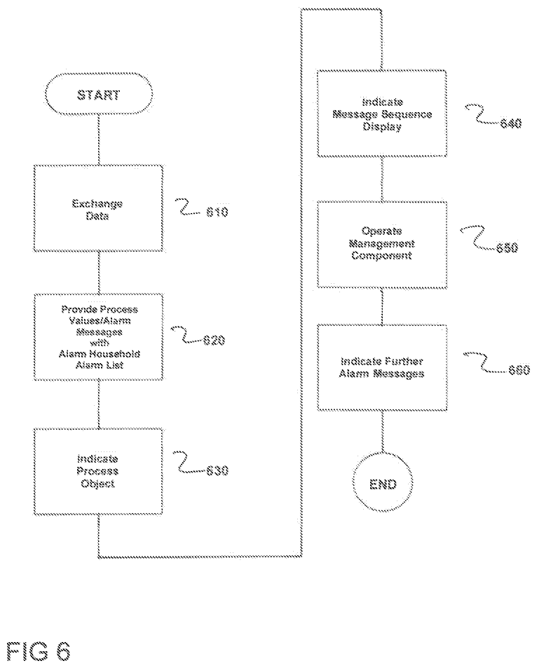

FIG. 2 shows an input/output window with input field for a short message in accordance with the invention;

FIG. 3 shows an input/output window with a view of an activated short message in accordance with the invention;

FIG. 4 shows an input/output window with a view of an acknowledged short message in accordance with the invention;

FIG. 5 shows a message sequence display with embedded short messages; and

FIG. 6 is a flowchart of the method in accordance with the invention.

### DETAILED DESCRIPTION OF THE EXEMPLARY EMBODIMENTS

A process monitoring system 100 is shown in FIG. 1. The process monitoring system 100 is connected to a first control unit 1 and to a second control unit 2 via a first bus system 11. The process monitoring system 100 is connected to an automation installation 10 via a second bus system 12. The automation installation 10 has, for instance, automation devices, decentralized peripheral devices and servomotors.

A server 3 of the process monitoring system 100 forms a core of the system, where the server 3 includes a visualization service 6 for monitoring the automation installation 10, where the visualization service is equipped with a variable household 8 for process values PV from a process image 7. The visualization service 6 is configured to supply at least the first control unit 1 with process values PV and alarm messages A1, where the first control unit 1 is further configured to display a process object 15, 16 with its process values PV in an input/output window 4.

The second control unit 2 is configured to display a message sequence display 14, where the first control unit 1 is likewise also configured to display the message sequence display 14, but in FIG. 1 within the first control unit 1 the input/output window and within the second control unit 2 the message sequence display 14 are each shown, respectively.

The input/output window 4, see also in FIGS. 2, 3, 4, the corresponding input/output windows 4a, 4b, 4c, is configured with an input field 20 for short messages M1, M2, M3 and further has an activation means 21.

A management component 5 for managing the process objects 15, 16 is configured to create an alarm instance 15a, 16a for the process object 15, 16 assigned to the input field 20 (see FIG. 2) when a short message M1, M2, M3 is input and an activation means 21 is activated, and to store the assigned short message M1, M2, M3 as a further alarm message A′ in the alarm list 13. The message sequence display 14 is configured to display the extended alarm message A′ from the alarm list 13 as short messages M1, M2, M3 (see to this end FIG. 5).

In accordance with the invention, the first control unit 1 exchanges data with the server 3 to operate the process monitoring system 100, where the server 3 is operated to monitor the automation installation 10 with the visualization service 6. The visualization service 6 contains the variable household 8 for the process values, where the process values are updated from the process image 7. Alarm messages A1 are provided from the alarm household 9 and the alarm list 13 via the visualization service 6 of the at least first control unit 1. When the input/output window 4 is called up, a user can indicate a process object 15, 16 with its process values PV on the first control unit 1.

In accordance with the invention, an input field 20 is now provided for short messages M1, M2, M3 via the first input window 4, and the short messages M1, M2 are activated via an activation means 21 (see FIG. 2), where a management component 15 for managing the process objects 15, 16 is operated in a first step S1 so that when a short message M1 is input and an activation means 21 is activated, an alarm instance 15a, 15b is created for the process object 15, 16 assigned to the input field 20. In a second step S2, a message list 17 is filled with the short messages M1, M2, M3. In a third step S3, the assigned short messages M1, M2, M3 are stored as further alarm messages A′ in the alarm list 13, where within the message sequence display 14 the further alarm messages A′ from the alarm list 13 are shown in a fourth step S4 as short messages M1, M2 M3.

In terms of communication, the first control unit 1 and the second control unit 2 are connected to the server 3 via a first bus system 11, where the automation installation 10 is likewise connected to the server 3 via a second bus system 12, and where a process interface 12a for the preparation of the process values PV is integrated in the server 3.

FIG. 2 shows an input/output window 4a with input field for a short message M1, M2, M3. The input field 20 for a short message M1, M2, M3 additionally has an activation means 21 in a tool bar. This activation means 21 is configured as a checkbox “trigger alarm”.

FIGS. 2, 3 and 4 accordingly show an exemplary embodiment for illustrating the application and use of the short message service, interacting with an alarm management and introduced by this invention, of process objects for an improved operation and observation for the users or operators of the control units. The input/output window 4a with input field 20 for a short message M1, M2, M3 is formed as a face plate in accordance with FIG. 2. The input field 20 can be opened from this face plate, and it enables a user to store short messages for the corresponding process object 15, 16. The input field 20 has the activation means 21 with a checkbox “trigger alarm” as an option, if the user would also like to trigger a corresponding reminder alarm when creating the short message M1, M2, M3, if for instance a valve has to be closed again manually at a specific time, for instance, then he can enter this into the input field 20 as an important short message.

FIG. 3 shows an input/output window 4b with a view of an activated short message M1, M2, M3. In a status field, it is indicated that a user (admin) has entered the short message M1=“close valve 10.00 pm” at time 1.55 pm on 20.02.2020. A confirmation means 24 indicates that it is desirable for this short message to subsequently appear in a message sequence display 14 as an alarm message and additionally to be activated.

As shown, a user can now identify that this is a still active memo or an active short message with an activated reminder alarm. Since according to the prior art it was previously disadvantageous that entries of memos or short messages could be overlooked, with the disclosed embodiments of the invention a triggered alarm from a short message is also visible in the message sequence display 14, and additionally in an acknowledgement-requiring manner, the short message can accordingly no longer get lost.

An input/output window 4c with a view of an acknowledged short message M1 is shown with FIG. 4. An acknowledgement 23 is shown in the status field 22. Accordingly, it is indicated in the input/output window 4c with the view of an acknowledged short message that an operator control action has been completed and confirmed. After completing the operator control action, here in the example “close valve 10.00 pm”, the short message is recorded in a history, from which it can likewise be determined that the short message is a triggered reminder alarm event which is advantageous for a subsequent audit trail.

FIG. 5 shows a message sequence display 14, where the message sequence display 14 is shown in a table. Shown in a first column is a time stamp 50, in a second column a name of the process object 51, in a third column a host/IP address 52, in a fourth column a user 53, and in a fifth column a message text 54. An additional display 55 for a trigger alarm and a means for the detailed display 56 are additionally shown in the fifth column for the message text 54.

With the first time stamp T1, a first short message M1 occurred, with a second time stamp T2 a short message M2 occurred, and with a third time stamp T3 a third short message M3 occurred. With a fourth time stamp T4, a “normal” alarm A1 occurred. With a fifth time stamp T5, the event occurred that, for instance, the third short message M3 was acknowledged by the process object “monane 2”.

In accordance with the invention, FIG. 5 now shows the message sequence display 14 in the reminder alarms triggered by the short messages M1, M2, M3. If an alarm is active and is not yet acknowledged, that is made known by a change in color in an alarm row. The operator responsible for the operator control action is therefore continuously reminded of the outstanding operation of the instruction, such as the first short message M1, until he has acknowledged the execution of the operator control action relating to the first short message M1, or in the input field for short messages 20 himself revokes the “trigger alarm” option or sets the memo to inactive.

FIG. 6 is a flowchart of the method for operating a process monitoring system 100. The method comprises exchanging data between at least one first control unit 1 exchanges data and a server 3, as indicated in step 610. In accordance with the invention, the server 3 is operated to monitor an automation installation 10 with a visualization service 6 that updates the process values PV from a process image 7 with a variable household 8 for process values PV.

Next, process values PV and alarm messages A1 with an alarm household 9 and an alarm list 13 including alarm messages A1 are provided via a visualization service 6 of the at least first control unit, as indicated in step 620.

Next, the at least one first control unit 1 indicates a process object 15, 16 with its process values PV when called up by a user in an input/output window 4, as indicated in step 630.

Next, a message sequence display with alarm messages from the alarm list 13 is indicated in the first control unit 1, as indicated in step 640. Here, the input/output window 4 provides an input field 20 for short messages M1, M2, M3 and the short message M1, M2, M3 is activated via an activation means 21.

Next, a management component 15 for managing the process objects 15, 16 is operated such that, when a short message M1, M2, M3 is input and an activation means 21 is activated for the process object 15, 16 assigned to the input field 20, an alarm instance 15a, 16a is created and the assigned short message M1, M2, M3 is stored in the alarm list 13 as a further alarm message A′, as indicated in step 650.

Next, further alarm messages A′ from the alarm list 13 are indicated as short messages M1, M2, M3 in the message sequence display 14, as indicated in step 660.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A process monitoring system comprising:
a server having (i) a visualization service for monitoring an automation system, said visualization service being configured with a variable household for process values from a process image, (ii) an alarm list including alarm messages and an alarm household;
at least one first control unit connected to the server, the visualization service being configured to supply the at least first control unit with the process values and the alarm messages, the at least one first control unit being configured to indicate a process object via the process values in an input/output window, the at least one first control unit being further configured to indicate a message sequence display with alarm messages from the alarm list, and the input/output window including an input field for short messages and furthermore includes an activation means;
a management component for managing process objects, said management module being configured to create an alarm instance for a process object assigned to the input field when a short message is input and an activation means is activated, and being further configured to store an assigned short message as a further alarm message in the alarm list;
wherein the message sequence display is extended to indicate further alarm messages from the alarm list as short messages.

2. The process monitoring system as claimed in claim 1, wherein the further alarm messages with the assigned short messages have a reference to the alarm instances.

3. The process monitoring system as claimed in claim 1, wherein a message list is present as an archive for the assigned short messages.

4. The process monitoring system as claimed in claim 2, wherein a message list is present as an archive for the assigned short messages.

5. The process monitoring system as claimed in claim 2, wherein the process objects have a data network and the data network in addition to other data types has the reference.

6. The process monitoring system as claimed in claim 3, wherein the process objects have a data network and the data network in addition to other data types has the reference.

7. The process monitoring system as claimed in claim 2, wherein the message sequence display further includes means for detailed display of the process object assigned to the short message utilizing the reference.

8. The process monitoring system as claimed in claim 3, wherein the message sequence display further includes means for detailed display of the process object assigned to the short message utilizing the reference.

9. The process monitoring system as claimed in claim 5, wherein the message sequence display further includes means for detailed display of the process object assigned to the short message utilizing the reference.

10. The process monitoring system as claimed in claim 1, wherein the message sequence display is configured to display the short message as an acknowledgement-requiring alarm message and accordingly an acknowledgement mechanism is available.

11. A method for operating a process monitoring system, the method comprising:
exchanging data between at least one first control unit exchanges data and a server, the server being operated to monitor an automation installation with a visualization service which updates the process values from a process image with a variable household for process values;
providing process values and alarm messages with an alarm household and an alarm list including alarm messages via a visualization service of the at least first control unit;
indicating by the at least one first control unit, a process object with its process values when called up by a user in an input/output window;
indicating, in the first control unit, a message sequence display with alarm messages from the alarm list, the input/output window providing an input field for short messages and the short message is activated via an activation means;
operating a management component for managing the process objects such that, when a short message is input and an activation means is activated for the process object assigned to the input field, an alarm instance is created and the assigned short message is stored in the alarm list as a further alarm message; and
indicating further alarm messages from the alarm list as short messages in the message sequence display.

12. The method as claimed in claim 11, wherein a reference relating to the alarm instances is assigned to the further alarm messages with the assigned short messages.

13. The method as claimed in claim 11, wherein a message list as an archive is filled with the assigned short messages.

14. The method as claimed in claim 12, wherein a message list as an archive is filled with the assigned short messages.

15. The method as claimed in claim 12, wherein the process objects are produced with a data network and the reference is assigned to the data network in addition to other data types.

16. The method as claimed in claim 13, wherein the process objects are produced with a data network and the reference is assigned to the data network in addition to other data types.

17. The method as claimed in claim 11, wherein the message sequence display is operated with a means for detailed display of the process object assigned to the short message and to this end the reference is used to call up the details.

18. The method as claimed in claim 11, wherein the message sequence display represents the short message as an acknowledgment-requiring alarm message and accordingly an acknowledgement mechanism is provided for a user.
